(19) United States
(12) Patent Application Publication
(10) Pub. No.: US 2003/0150474 A1
(43) Pub. Date: Aug. 14, 2003

(54) Dental floss dispenser and applicator

(76) Inventor: Michael A. Doyscher, LaSalle (CA)

Correspondence Address: Philip R. Warn, Warn, Burgess & Hoffmann, PC, P.O. Box 70098, Rochester Hills, MI, 48307, US

(21) Appl. No.: 10/039,274

(22) Filed: Jan. 2, 2002

Related U.S. Application Data
(60) Provisional application No. 60/259,417, filed on Jan. 2, 2001.

(51) Int. Cl. A61C 15/00

(52) U.S. Cl. 132/325

(57) ABSTRACT

A dental floss dispenser and applicator housing a supply of dental floss that also serves as an applicator to assist the user in cleaning spaces between the teeth.

### FIELD OF THE INVENTION

This invention generally relates to a dental floss dispenser and applicator that can house a supply of dental floss and serve as an applicator to assist a user to clean areas between the teeth. More particularly, the present invention relates to an improved dental floss dispenser and applicator capable of housing a supply of dental floss and, at the same time, retaining a strand of floss under tension in order to permit the device to be used to manipulate dental floss between the teeth and move it back and forth for cleaning purposes.

### BACKGROUND AND SUMMARY OF THE INVENTION

It has long been recognized that good dental hygiene is an essential part of a healthy lifestyle. In this respect, there have been advances in dental chemical technology with respect to toothpaste, mouth rinses and cleaning instruments. All are designed to prevent tooth decay and gum disease and, ultimately, tooth loss.

For example, a toothbrush is a widely used implement to scour and clean teeth. Brushing teeth with toothbrushes is an effective way to clean dental surfaces that oppose the cheeks, lips and tongue. It is not as effective, however, to scour and clean plaque and food from areas between the teeth.

Dental instruments known as scalers and probes are also used for teeth and gum cleaning. A scaler has a probe end with a cutting surface used to remove tartar and plaque from teeth. A dental probe has a pointed end that is usually bent away from the longitudinal axis of the probe's handle, and is used to locate and clean indentations and cavities in the teeth. But, the problem with these instruments is that they are designed and intended for use by oral health care professionals only, and are not suited for general public use.

Oral health care professionals have also come to appreciate the importance of daily flossing. Dental floss is a strong, thin thread. Often, the thread is waxed so as to make the insertion of the floss between teeth somewhat easier. The terminal ends of the dental floss are generally wound about the index finger of each hand of the user. Following that, the free length of the floss between the user's fingers is inserted into the spaces between the use's teeth. Studies have proven that flossing is highly effective in removing plaque and reducing gingivitis.

However, flossing can be a time consuming and often-unpleasant chore. It is well known that the many problems associated with flossing cause people to not floss on a regular basis. It is difficult, for example, to insert the fingers from one or both hands into the mouth. Sometimes, the force applied to get the floss between the teeth is excessive. As a result, the floss snaps into the gums causing them to bleed.

Moreover, wrapping the floss around one's fingers in order to maintain the tension necessary to insert the floss between the teeth can be difficult and painful. This is especially so where the user lacks manual dexterity, as is often the case with children, senior citizens, and the physically challenged. Note too that those with arthritic conditions often find flossing to be too painful an exercise to engage in on a regular basis. In short, physical limitations can make flossing, as well as mastering the techniques of correctly using and administering hand-held dental floss, all but impossible.

And, although floss is relatively inexpensive, much is wasted when used in the traditional manner. Consider, for example, the amount of floss employed at the terminal ends that are wrapped about the user's index fingers. While necessary to ensure a good grip and to maintain the proper tension necessary for inserting the floss between the user's teeth, it is often many times greater in length than the few inches actually required for cleaning purposes. This loss will be particularly significant when flossing is done as often it should be, as part of a daily regime of dental fitness for good oral health care.

In an effort to overcome one or more of the above-identified problems, there are at present a number of dental floss tools that are the subjects of patents and/or are commercially available. One example is found in U.S. Pat. No. 4,162,687 (“the '687 patent”) to Lorch.

In the '687 patent, a flossing device is described that has a handle with a pair of resilient arms. Fingers extend from the arms in the longitudinal axis of the fingers to form an angle of between 30 degrees and 180 degrees with each other. Each finger has a knob at its end. A length of flossing material is in turn connected to each of the fingers.

While the '687 patent to Lorch addresses some of the above-discussed problems, it still has shortcomings. Notably, the Lorch patent requires individual, flossing material that is connected to grommets, which are then connected to the fingers attached to the arms of the tool. The cost associated with attaching grommets to a length of dental floss, and the unwieldy packaging required as a result, would likely offset any cost savings that might be attributable to using less floss.

U.S. Pat. No. 5,573,021 (“the '021 patent”) to Grofcisk, et al., on the other hand, describes a dental floss applicator wherein a supply of dental floss is contained within the handle of the applicator. Again, the applicator comprises a fork with a pair of elongated legs projecting from a handle. To anchor the floss in order to provide the appropriate tension for cleaning the spaces between the teeth, a button is mounted on the applicator. In using the floss applicator, the dental floss pulled from the handle is first wrapped one or two times around the button. The floss is then inserted into the grooves along the left and right fork of the applicator, and back up to the button. Following that, the floss is again wrapped one or two turns around the button in order to anchor the floss. Thus, the button is the only anchor that maintains the tension in the floss necessary to accommodate its intended purpose.

But the Grofcisk applicator has several drawbacks. First, the button/anchor is comprised of an outer knob attached to the applicator via a tapered constricting stem. In winding floss around the button before and after the fork portion of the applicator, it is observed that the floss becomes tangled and extremely difficult to unwind and reset for subsequent use. Consequently, when trying to advance the floss, the same sorts of difficulties associated with using hand-held floss are also present. That is, those lacking manual dexterity will likely find the Grofcisk applicator as difficult to use as ordinary floss, and, as a result, fail to floss as often as they should.

In addition, the fork portion of the Grofcisk applicator is offset to one side of the longitudinal axis of the handle portion via a double bend in the transition segment between the fork portion and the handle portion. While the offset makes it somewhat easier to floss the area on one side of the mouth, it is also noted that the offset makes it more difficult to floss the area on the opposite side. Specifically, the cheek of the user will interfere with flossing when using the Grofcisk applicator on the side of the mouth towards where the offset is directed.

Finally, U.S. Pat. No. 5,188,133(“the '133 patent”) Romanus is also directed to a dental flossing tool. The Romanus tool is comprised of an elongated cylinder constituting a handle portion having at one end an extension with a forked end and curved prongs. Unlike the Gorfcisk applicator, the Romanus dental flossing tool employs two locking mechanisms in order to keep the floss under sufficient tension between the two prongs to allow insertion of the floss between the user's teeth. However, the two locking mechanisms are controlled by a single external control, and, thus, can only be activated or deactivated at the same time.

In contrast, the present invention is directed to a dental floss dispenser and applicator having at least two locking mechanisms that are not linked. In this regard, the present invention comprises a substantially hollow, elongated handle portion having a first end and a second end. The first end defines a housing for a push button platen and a gear reel having a supply of dental floss.

In the preferred embodiment, the push button platen is affixed to the elongated handle, and a gear reel with a supply of dental floss is seated upon the push button platen within the housing. The gear reel is biased by a spring into a position where it engages one or more posts that are attached to an interior wall of the housing, thus keeping the gear reel in a locked position. By depressing a button on the push button platen, the gear reel moves into an unlocked position by disengaging from the posts, thus allowing a selected amount of dental floss to be withdrawn from an opening on the elongated handle portion. When the button is released, the spring biases the gear reel back to the locked position.

Attached to the second end of the elongated handle is a fork having a pair of elongated legs. The elongated legs define a span, and each leg has a groove that is designed to engage the dental floss.

Also attached to the second end of the elongated handle is a cleat around which dental floss may be wound. The cleat has a shelf with a slot, the slot being adapted to engage the dental floss so as to secure it, and to cut the dental floss that has been used.

Thus, in the preferred embodiment of the present invention, a selected amount of dental floss is pulled from the opening on the elongated handle via depressing the button on the push button platen, which in turn moves the gear reel along the same axis as the button and away from the posts allowing floss to be selectively withdrawn. When a desired amount of dental floss is withdrawn, the button is released, allowing the gear reel to return to the locked position. Then, the dental floss is fitted onto the grooves of each of the legs, and, ultimately, wound around the cleat and inserted into the slot so that the dental floss spanning the legs is under sufficient tension to permit the user to insert and clean areas between the teeth.

### BRIEF DESCRIPTION OF THE DRAWINGS

FIG. 1 is a perspective view of one embodiment of the present invention;

FIG. 2 is an exploded view of another embodiment of the present invention;

FIG. 3 is a front view of the embodiment shown in FIG. 2;

FIG. 4 is a cross sectional view along the longitudinal axis of the embodiment shown in FIG. 2;

FIG. 5 is a cross sectional view along a plane perpendicular to the longitudinal axis of the embodiment shown in FIG. 2, with the gear reel in a locked position;

FIG. 6 is the same cross sectional view as that shown in FIG. 5, with the gear reel in an unlocked position; and

FIG. 7 is a side view of the present invention.

### DETAILED DESCRIPTION OF THE INVENTION

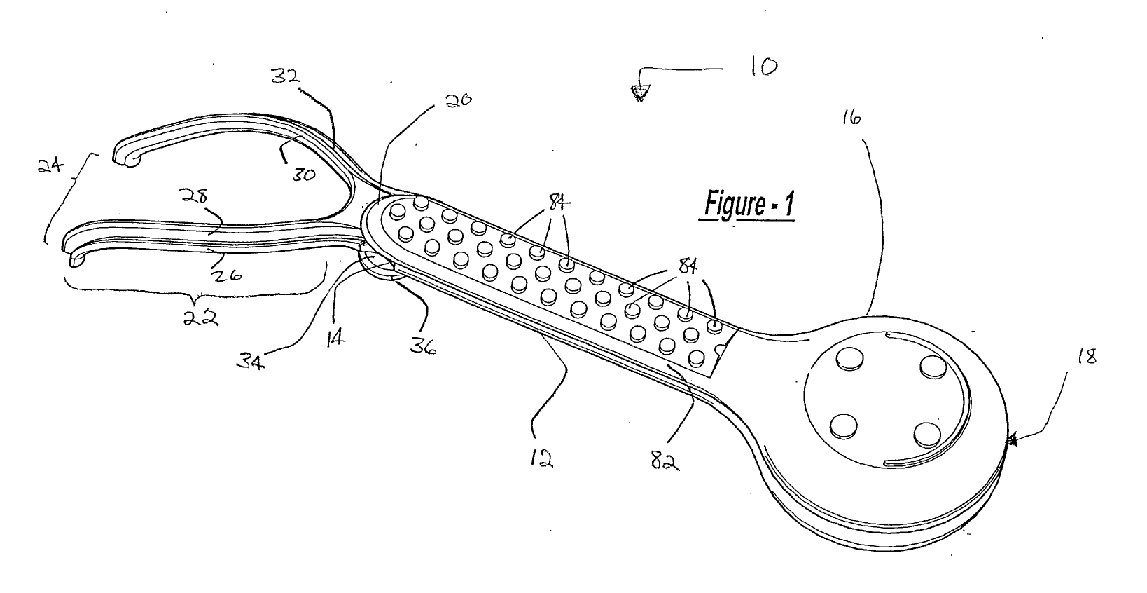

One embodiment of the dental floss dispenser and applicator according to this invention is shown in FIG. 1. A dental floss dispenser and applicator 10 has an elongated handle 12 with an opening 14. The first end 16 of the elongated handle 12 defines a housing 18, shown in FIGS. 4, 5 and 6, in which a supply of dental floss 56 may be maintained.

Attached to a second end 20 of the elongated handle 12 is a forked extension 22 which defines a span 24. The forked extension 22 is comprised of a first leg 26 having a first groove 28 and a second leg 30 having a second groove 32. Thus, in this embodiment, dental floss 56 can be withdrawn from the opening 14 on elongated handle 12, fitted into the first groove 28 of the first leg 26 of the forked extension 22, across the span 24, and back up to second groove 32 on the second leg 30 of the forked extension 22.

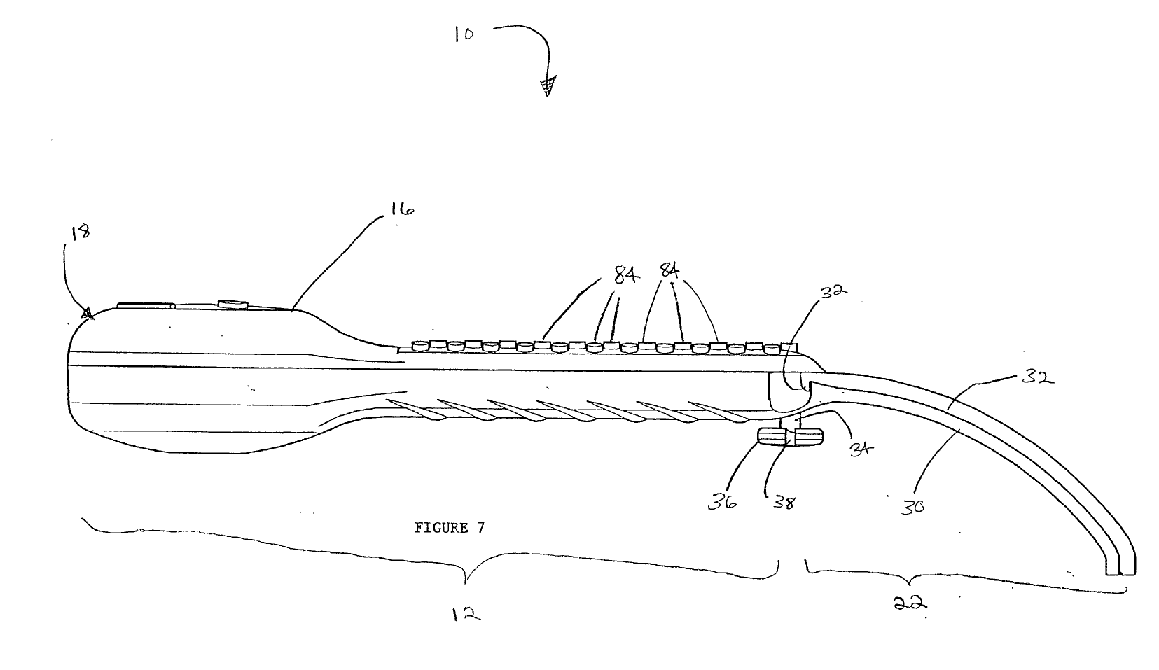

As is best shown in FIG. 7, also attached to the second end 20 of the elongated handle 12 is a cleat 34. The cleat 34 has a shelf 36 that extends from an end of the cleat that is distal to the elongated handle 12 in a plane substantially perpendicular to the longitudinal axis of the cleat 34. The shelf 36 has a slot 38, the slot being adapted to engage the dental floss 56 so as to secure it, and to cut the dental floss 56 that has been used.

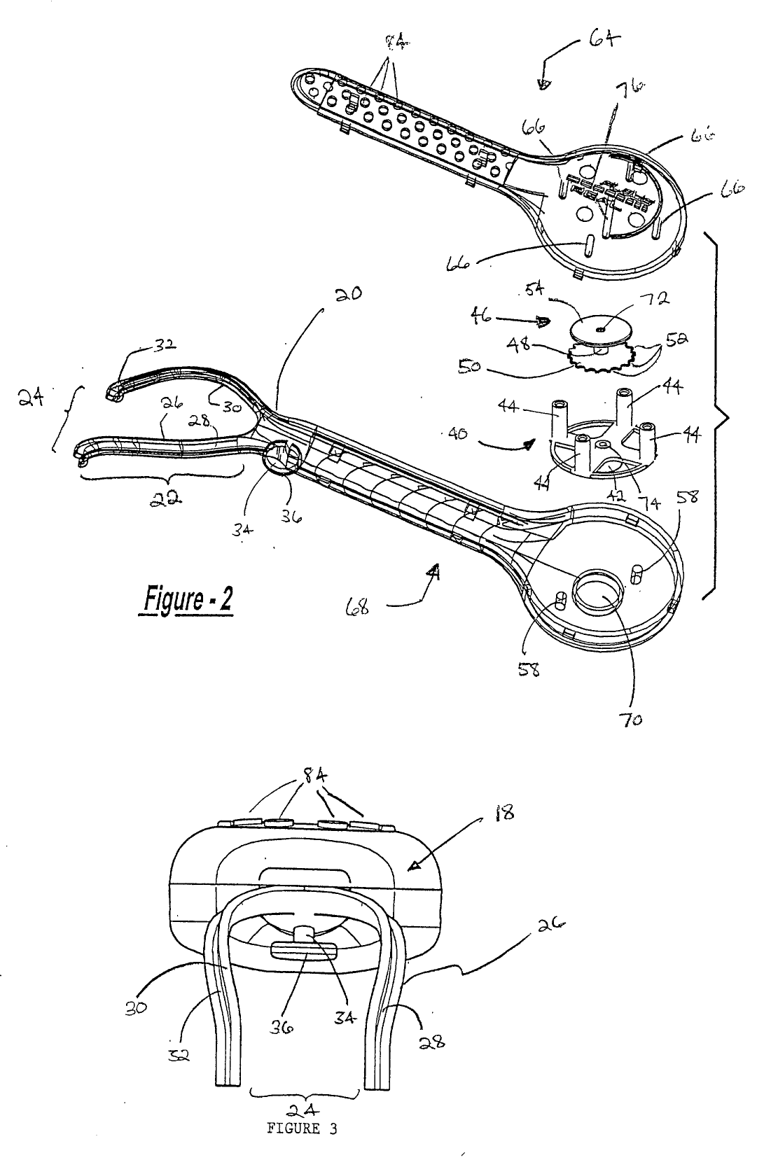

Another embodiment of the present invention is shown in FIGS. 2 and 3. The dental floss dispenser and applicator 10 is comprised of a top shell 64 and a bottom shell 68. Again, attached at the second end 20 of elongated handle 12 is a forked extension 22. The forked extension 22 is comprised of a first leg 26 with a first groove 28 and a second leg 30 with second groove 32 that define a span 24. The housing 18 at the first end 16 of elongated handle 12 is substantially hollow. In addition, bottom shell 68 of dental floss dispenser and applicator 10 has an aperture 70 adapted for receiving a button 42 from push button platen 40. In this particular embodiment, bottom shell 68 has an inner wall 62 having one or more posts 58.

As indicated above, push button platen 40 has a button 42 adapted to fit into aperture 70 of the bottom shell 68 of dental floss dispenser and applicator 10. Push button platen 40 also has a plurality of retaining members 44. Seated on push button platen 40 within the housing 18 of the first end 16 of the dental floss dispenser and applicator 10 is a gear reel 46 having supply of dental floss 56. As is also shown in FIGS. 4, 5 and 6, gear reel 46 is comprised of a cylindrical member 48, the cylindrical member having a first shoulder 50 and a second shoulder 54. The first shoulder 50 and second shoulder 54 of gear reel 46 extend in planes that are substantially perpendicular to the longitudinal axis of the cylindrical member 48 of gear reel 46. First shoulder 50 of gear reel 46 has a plurality of teeth 52 designed to engage posts 58 in this particular embodiment.

Referring again to FIG. 2, top shell 64 of dental floss dispenser and applicator 10, has a plurality of shafts 66 such that the retaining members 44 of push button platen 40 can fittingly engage the shafts 66 of top shell 64 when the top shell 64 and the bottom shell 68 are fitted together.

Note too that attached to second end 20 of elongated handle 12 of the invention embodied at FIGS. 2 and 3, is forked extension 22 having a first leg 26 with a first groove 28 and a second leg 30 having a second groove 32 defining a span 24. Also attached to second end 20 of elongated handle 12 is a cleat 34 having a shelf 36.

Thus, in this embodiment of the present invention, a selected amount of dental floss 56 may be withdrawn from the opening 14 in elongated handle 12 via depressing the button 42 of push button platen 40. The movement of the button 42 and push button platen 40 in turn causes the gear reel 46 with the supply of dental floss 56 to move away from the posts 58 allowing dental floss to be withdrawn. When the desired amount of dental floss 56 is withdrawn, the button 42 of push button platen 40 is released, allowing the teeth 52 on first shoulder 50 of gear reel 44 to re-engage the posts 58, thereby maintaining the gear reel 46 in a locked position.

Then, the dental floss 56 is fitted into first groove 28 of first leg 26 of forked extension 22, across space 24, and into second groove 32 of second leg 30 of forked extension 22. The dental floss 56 is then wound around the cleat 34 beneath the shelf 36 so that the dental floss 56 fitted across the span 24 defined by first leg 26 and second leg 30 of forked extension 22 is under sufficient tension to allow the user to insert dental floss 56 to clean areas between the user's teeth.

Turning now to FIGS. 4, 5 and 6, the embodiment of the invention set forth in FIG. 2 is shown in exploded view. Specifically, the first end 16 of elongated handle 12 forms a housing for one kind of mechanism that can serve to selectively permit dental floss 56 to be retained or withdrawn by user from the opening 14 on the elongated handle 12. Specifically, FIG. 4 shows a cross-sectional view of elongated handle 12 wherein a button 42 on push button platen 40 is inserted into an aperture 70 of bottom shell 68. Push button platen 40 has a plurality of retaining members 44. Seated on push button platen 40 within the housing 18 of the first end 16 of the elongated handle 12 is a gear reel 46. Gear reel 46 comprises a cylindrical member 48, the cylindrical member having a first shoulder 50 and a second shoulder 54. First shoulder 50 and second shoulder 54 of gear reel 46 extend in planes which are substantially perpendicular to the longitudinal axis of the cylindrical member 48 of gear reel 46.

As is best shown in FIG. 2, first shoulder 50 of gear reel 46 has a plurality of teeth 52 designed to engage posts 58 rotated on inner wall 62 of bottom shell 68. The top shell 64 of elongated handle 12, on the other hand, has a plurality of shafts 66 such that retaining members 44 of push button platen 40 can fittingly engage the shafts 66 of top shell 64 when top shell 64 and bottom shell 68 are fitted together. Note that top shell 64 also has a pole 76 designed to fittingly engage an opening 72 in gear reel 46, and an opening 74 in push button platen 40. That is, gear reel 46 has an opening 72 through the longitudinal axis of the cylindrical member 48. The push button platen 40 likewise has an opening 74 such that when gear reel 46 is seated on push button platen 40, pole 76 of top shell 64 may fittingly engage the two.

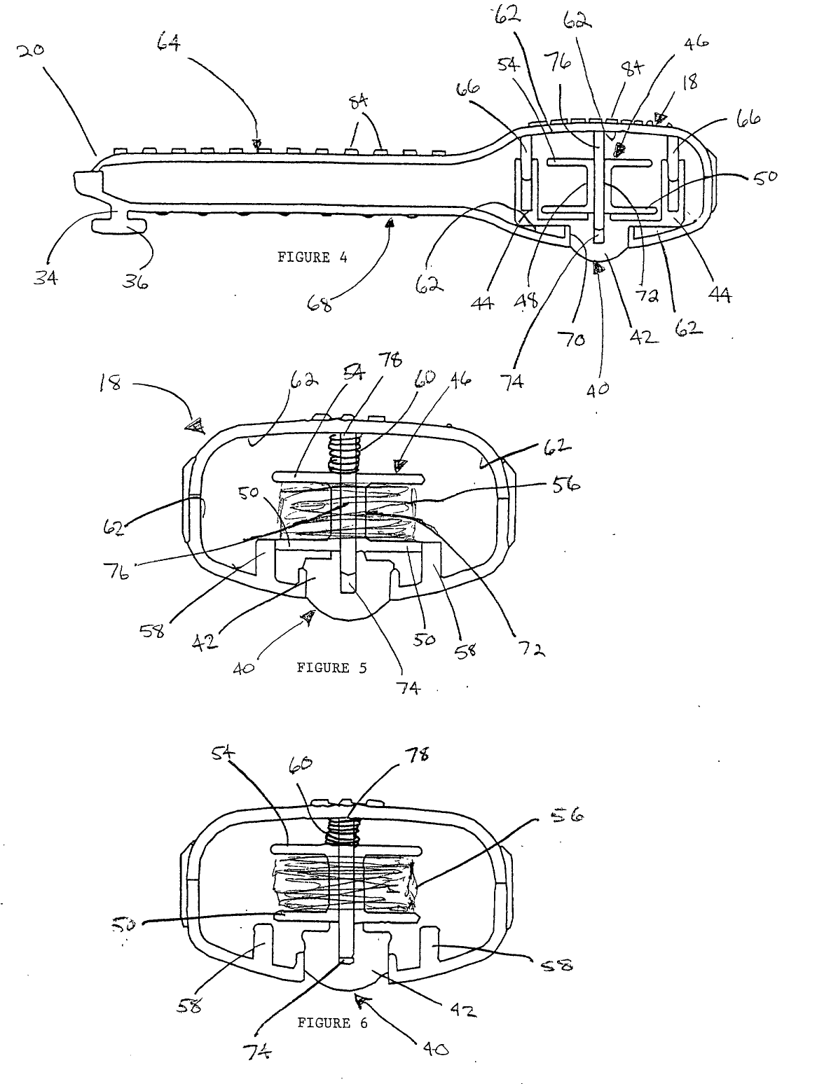

As shown in FIG. 5, gear reel 46 is shown in a locked position wherein dental floss 56 is selectively retained. More specifically, first shoulder 50 of gear reel 46 is engaged to posts 58 attached to the inner wall 62 of housing 18 of the first end 16 of elongated handle 12. When button 42 of push button platen 40 is depressed, however, gear reel 46 moves into an unlocked position allowing dental floss 56 to be selectively withdrawn from opening 14 of elongated handle 12.

In FIG. 6, on the other hand, gear reel 46 is shown in an unlocked position. Here, button 42 of push button platen 40 is depressed, thereby allowing the teeth 52 of first shoulder 50 of gear reel 46 to move away from posts 58 attached to the inner wall 62 of the bottom shell 68 of housing 18 of the first end 16 of the elongated handle 12. As is shown in FIGS. 5 and 6, gear reel 46 can be biased into the locked position by the addition of a spring 60 seated upon the second shoulder 54 of gear reel 46 and in communication with the inner wall 62 of top shell 64. To keep the spring 60 in place, pole 76 of top shell 64 may be fitted through the opening in the spring 78, through the opening 72 of the cylindrical member 48 of the gear reel 46, and into the opening 74 of the push button platen 40.

In FIG. 7, is provided for showing that an exterior surface 82 of dental floss dispenser and applicator 10 may have a plurality of nubs 84 to assist the user in gripping the elongated handle 12. In addition, FIG. 7 shows the slot 38 on cleat shelf 36 of cleat 34. As noted above, the slot 38 is especially adapted to engage the dental floss 56 so as to secure it, and to cut the dental floss 56 that has been used.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A dental floss dispenser and applicator comprising;
a substantially hollow elongated handle having an opening and a first end and a second end, the first end defining a housing for dental floss and a mechanism that allows the dental floss to be selectively retained or withdrawn by a user from the opening on the elongated handle;
a forked extension extending from the second end of the elongated handle, the forked extension having a span defined by a first leg with a first groove and a second leg with a second groove; and
a cleat affixed to the elongated handle, whereby the dental floss can be fitted in the first groove of the first leg of the forked extension, across the span, in the second groove of the second leg, and attached to the cleat.

2. The dental floss dispenser and applicator according to claim 1 wherein the mechanism comprises a push button platen that is affixed to the elongated handle, a gear reel having a first shoulder with a plurality of teeth and a supply of dental floss that is seated on the push button platen, and a post located within the housing of the elongated handle for engaging the teeth on the first shoulder of the gear reel so that the user, by depressing a button on the push button platen, engages or disengages the teeth of the gear reel from the post thereby allowing dental floss to be selectively retained or withdrawn from the opening on the elongated handle.

3. The dental floss dispenser and applicator according to claim 2 wherein the teeth on the first shoulder of the gear reel are biased in a position that is engaged to the post by a spring that is seated upon a second shoulder of the gear reel and in communication with an inner wall of the housing.

4. The dental floss dispenser and applicator according to claim 2 wherein the teeth on the first shoulder of the gear reel are biased in a position that is disengaged from the post by a spring that is seated upon a second shoulder of the gear reel and in communication with an inner wall of the housing.

5. The dental floss dispenser and applicator according to claim 1 wherein the cleat has a shelf extending in a plane substantially perpendicular to the longitudinal axis of the cleat, the shelf located at an end of the cleat that is distal to the elongated handle.

6. The dental floss dispenser and applicator according to claim 5 wherein the shelf of the cleat has a slot adapted to selectively retain and cut dental floss.

7. The dental floss dispenser and applicator according to claim 1 wherein the elongated handle comprises a top shelf, a bottom shelf, and a push button platen affixed to the bottom shelf, the top shelf having a plurality of shafts and the push button platen having a plurality of retaining members such that the retaining members on the push button platen may fittingly engage the shafts on the top shelf when the top shelf and bottom shelf are fitted together.

8. The dental floss dispenser and applicator according to claim 7 wherein the bottom shelf has an aperture through which a button mounted on the push button platen is inserted when the top shelf and the bottom shelf of the elongated handle are fitted together, whereby the user may depress the button to selectively retain or withdraw dental floss from the opening on the elongated handle.

9. The dental floss dispenser and applicator according to claim 8 wherein a gear reel having a first shoulder with a plurality of teeth and a supply of dental floss is seated on the push button platen, and a post is located within the housing of the elongated handle so that the user, when depressing the button on the push button platen, engages or disengages the teeth on the first shoulder of the gear reel from the post allowing dental floss to be retained or withdrawn from the opening on the elongated handle.

10. The dental floss dispenser and applicator according to claim 9 wherein the gear reel and the push button platen have openings through their longitudinal axes whereby a shaft affixed to an inner wall of the top shelf of the elongated handle is inserted through the opening in the gear reel and into the opening in the push button platen when the top shelf and the bottom shelf of the elongated handle are fitted together.

11. The dental floss dispenser and applicator according to claim 10 wherein a spring is seated on a second shoulder of the gear reel and against the inner wall of the housing so that the teeth on the shoulder of the gear reel are biased in a position that is engaged to the post.

12. The dental floss dispenser and applicator according to claim 11 wherein a spring is seated on the second shoulder of the gear reel and against the inner wall of the housing so that the teeth on the first shoulder of the gear reel are biased in a position that is disengaged from the post.

13. A dental floss dispenser and applicator comprising;
an elongated handle having an opening and a first end and a second end, the first end defining a housing for a gear reel having a supply of dental floss seated upon a push button platen that is attached to the housing;
a forked extension extending from the second end of the elongated handle, the forked extension having a span defined by a first leg with a first groove and a second leg with a second groove; and
a cleat affixed to the elongated handle whereby a user, by depressing a button on the push button platen, engages or disengages the gear reel from a post located on an inner wall of the housing so that a user can selectively retain or withdraw dental floss through the opening on the elongated handle, fit the dental floss in the first groove of the first leg of the forked extension, across the span, and in the second groove of the second leg, and attach the dental floss to the cleat.

14. The dental floss dispenser and applicator according to claim 13 wherein the user, by depressing the button on the push button platen, disengages the gear reel from the post located on the inner wall of the housing defined by the elongated handle, whereby the gear reel can rotatably move on the push button platen permitting dental floss to be selectively withdrawn from the opening on the elongated handle.

15. The dental floss dispenser and applicator according to claim 13 wherein the button on the push button platen and the gear reel are biased in a position that is engaged to the post by a spring that is seated upon a second shoulder of the gear reel and in communication with an inner wall of the housing defined by the elongated handle.

16. The dental floss dispenser and applicator according to claim 13 wherein the user, by depressing the button on the push button platen, causes the gear reel to engage the post, whereby the gear reel is placed in a locked position so that dental floss cannot be withdrawn from the opening on the elongated handle.

17. The dental floss dispenser and applicator according to claim 16 wherein the button on the push button platen and the gear reel are biased in a position that is disengaged to the post by a spring that is seated upon a second shoulder of the gear reel and in communication with the inner wall of the housing defined by the elongated handle.

18. The dental floss dispenser and applicator according to claim 13 wherein the elongated handle has an exterior surface having a plurality of nubs to assist the user in gripping the elongated handle.

19. A gear reel comprising:
a cylindrical member having a first shoulder at the cylindrical member's first end and a second shoulder at the cylindrical member's second end, the first shoulder and the second shoulder extending in planes substantially perpendicular to the longitudinal axis of the cylindrical member, and the first shoulder having a plurality of teeth allowing the first shoulder to engage a post so as to keep the gear reel in a fixed position; and
a supply of dental floss wound about the cylindrical member between the first shoulder and the second shoulder whereby the gear reel, when disengaged from the post, can rotatably move to allow the dental floss to be withdrawn from the cylindrical member.

20. The gear reel according to claim 19 wherein the gear reel is seated upon a push button platen, the push button platen having a first side and a second side whereby a user, when depressing a button on the first side of the push button platen, causes the second side to move along the longitudinal axis of the button.

21. The gear reel according to claim 19 wherein the cylindrical member has an opening along its longitudinal axis, whereby the gear reel may engagingly receive a shaft.
